(19) United States
(12) Patent Application Publication
(10) Pub. No.: US 2007/0273471 A1
(43) Pub. Date: Nov. 29, 2007

(54) Systems and methods for controlling access to a site using a combination of identification technologies

(75) Inventors: Larry Shilling, Alfred Station, NY (US); Jerry Leone, Victor, NY (US); John Cronin, Jericho, VT (US); Nancy Edwards Cronin, Jericho, VT (US); Michael Bielski, Colchester, VT (US)

Correspondence Address: WILMER CUTLER PICKERING HALE AND DORR LLP, 1875 PENNSYLVANIA AVE., NW, WASHINGTON, DC, 20004, US

(73) Assignee: Casella Waste Systems, Inc., Rutland, VT (US)

(21) Appl. No.: 11/418,255

(22) Filed: May 5, 2006

(51) Int. Cl. G05B 19/00

(52) U.S. Cl. 340/5.2; 235/375; 340/5.71; 340/5.53

(57) ABSTRACT

Systems and methods for authorizing a vehicle to proceed beyond an access point are disclosed. In one embodiment of the invention, a system can include an identification reader configured to obtain various identification information from one or more identification mechanisms, a biometric reader configured to obtain biometric information from one or more persons, and a computer configured to receive the identification information and the biometric information. The computer determines whether the vehicle is authorized to proceed beyond the access point using the identification information and biometric information, and transmits a signal to a control mechanism to allow the vehicle to proceed beyond the access point.

### BACKGROUND OF THE INVENTION

1. Field of the Invention

Embodiments of the present invention relate to the field of controlling access to a site. In particular, embodiments of the present invention relate to systems and methods for authorizing a vehicle to enter or leave a site, using a combination of identification technologies.

2. Background Description

Many industries utilize various techniques to authorize passage of personnel and vehicles through access points of controlled sites, facilities, buildings and the like. Access points can be, for example, kiosks, booths, doorways, or gates. Authorization may include verifying the identification of vehicles, personnel, and/or vehicle affiliations. Authorization of a vehicle may include verifying vehicle qualifications, certifications, and/or specifications.

Currently, the access point authorization processes can require manual evaluation and verification of the driver, vehicle, hauler, driver and/or vehicle licenses, driver and/or vehicle certifications, driver and/or vehicle registrations, and/or vehicle specifications. We have discovered that a comprehensive evaluation of multiple authorization requirements is labor intensive and prone to errors.

Consider an example in the waste disposal business, in which landfills or transfer stations often need to authorize personnel and/or vehicles to enter these facilities. Present techniques invoke the use of dedicated personnel to manually inspect and authorize personnel and/or vehicles. This increases the operational costs of these facilities. In addition, entry of vehicles into the facilities can be delayed when many vehicles arrive at the facility within a short period of time. Therefore, there exists a need to automate the process by which personnel and/or vehicles can be authorized to pass through access points.

### SUMMARY OF EMBODIMENTS OF THE INVENTION

Embodiments of the present invention generally relate to systems and methods for automating the process of verifying vehicle and personnel identification (“ID”) information. Embodiments of the present invention can be used to evaluate multiple authorization requirements associated with an access point of a controlled site, advantageously reducing the labor, time, and risk of errors associated with dedicated personnel manually performing such verification.

One embodiment of the present invention is a system for authorizing a waste management vehicle to proceed beyond an access point of a waste receivable environment. The system includes an identification reader configured to obtain vehicle identification information, hauler identification information, and personnel identification information from one or more identification mechanisms. The system also includes a biometric reader configured to obtain biometric information from one or more vehicle personnel. Finally, the system includes a computer system configured to receive the identification information and the biometric information. The computer system is also configured to determine whether the vehicle and the personnel are authorized to proceed beyond the access point using the identification information and biometric information, and transmit a signal to a control mechanism to allow the vehicle and the personnel to proceed beyond the access point.

The identification reader of the system can be a barcode reader or a radio frequency identification (“RFID”) reader. In one embodiment, the identification reader is an RFID reader. The identification reader can be further configured to obtain information about contents of the vehicle from at least one content information mechanism.

The biometric reader of the system can be configured to obtain at least one of a fingerprint, a voice sample, a facial image, and an eye image of vehicle personnel. The scale can be configured to obtain the weight of the vehicle in determining if the vehicle is authorized to proceed beyond the access point.

In one embodiment, the system further includes a display, and the computer system is further configured to send a message to the display indicating whether the vehicle is authorized to proceed beyond the access point. The system may also include a gate access controller for allowing an authorized vehicle and personnel to proceed beyond the access point.

In some embodiments, the computer system is positioned proximate the access point. Alternatively, the computer system can include a computer remotely accessed via a network, the computer storing data pertaining to vehicle, hauler, and personnel authorization requirements. Other data depositories may include, for example, a personnel repository, a hauler repository, a vehicle repository, a materials repository, an access criteria repository, a biometrics repository, and an operations repository.

The system can also confirm that the vehicle has exited from the access point by receiving a second time at least one of the vehicle identification and biometric information. When the system does not receive the second vehicle identification or biometric information within a predetermined time period of receiving the initial vehicle identification and biometric information, the system may provide a visual and/or audible alert.

A method for authorizing a waste management vehicle to proceed beyond an access point of a waste receivables environment is also disclosed. The method can include reading waste management vehicle identification information, hauler identification information, and personnel identification information from at least one identification tag, reading biometric information from at least one person, and determining whether the vehicle is authorized to proceed beyond the access point from the identification information and/or the biometric information. The method can further include allowing the vehicle to proceed beyond the access point upon determining that the vehicle is authorized.

In some embodiments, the act of reading identification information includes reading at least one barcode. Alternatively, the act includes reading at least one RFID tag. In one embodiment, the act of reading identification information includes reading an RFID tag identifying the vehicle and reading an RFID tag identifying personnel of the vehicle. The biometric information can include a fingerprint, a voice sample, a facial image, and/or an image of an eye.

In one embodiment, the weight of the vehicle can be used to determine whether the vehicle is authorized to proceed beyond the access point. The system(s) and method(s) can also include displaying whether the vehicle is authorized to proceed beyond the access point. Furthermore, the system(s) and method(s) can include allowing the vehicle to proceed beyond the access point using an automated gate access controller, upon determining that the vehicle is authorized. The determination can be based at least in part upon contents of the vehicle.

Before explaining embodiments of the invention in detail, it is to be understood that embodiments of the invention are not limited in their application to the details of construction and to the arrangements of the components set forth in the following description or illustrated in the drawings. The invention is capable of other embodiments and of being practiced and carried out in various ways.

### BRIEF DESCRIPTION OF THE DRAWINGS

The Detailed Description of the Invention, including the description of various embodiments of the invention, will be best understood when read in reference to the accompanying figures wherein:

FIG. 1 is a functional block diagram depicting an exemplary embodiment of a first access control system in accordance with the present invention;

FIG. 2 is a flow chart illustrating a first exemplary method of controlling access to a site;

FIG. 3 is a functional block diagram depicting an exemplary embodiment of a second access control system in accordance with the present invention; and

FIG. 4 is a flow chart illustrating a second exemplary method of controlling access to a site.

### DETAILED DESCRIPTION OF THE INVENTION

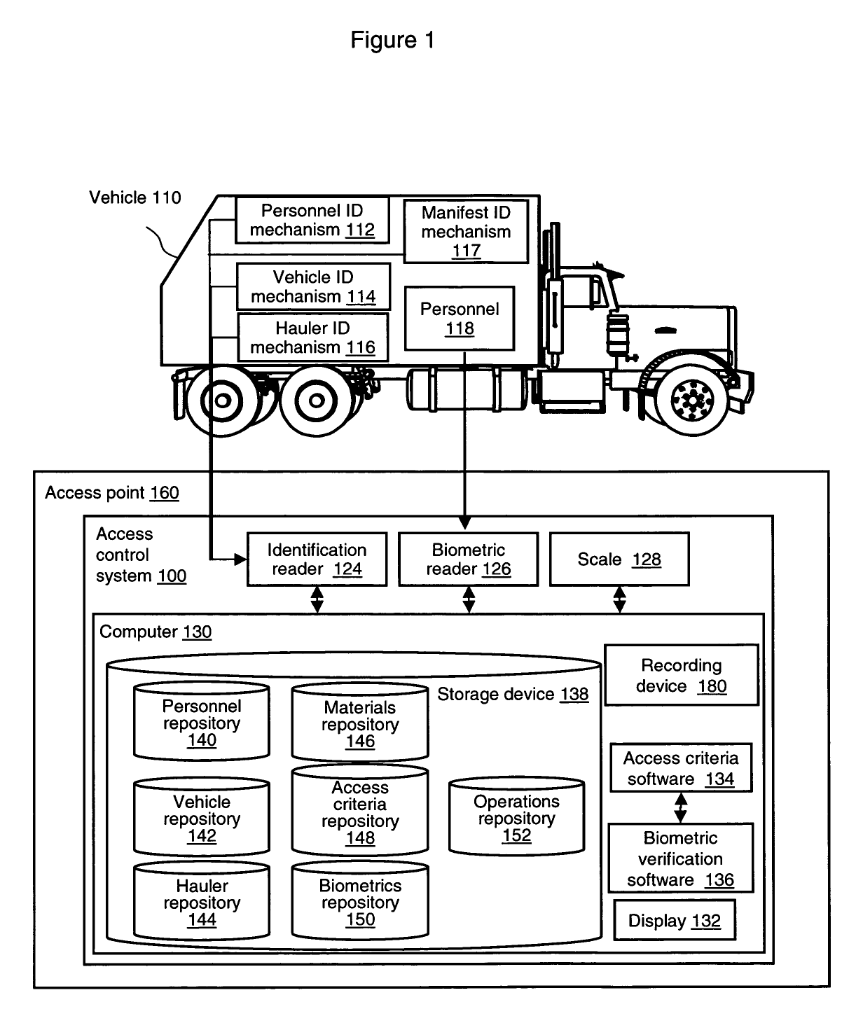

FIG. 1 is a functional block diagram of access control system 100 and vehicle 110. Access control system 100 can include identification reader 124, biometric reader 126, scale 128, and computer 130.

Access control system 100 can be installed at, or in connection with, access point 160 of a controlled site. The controlled site can be, for example, a transfer station in a waste receivable environment or landfill, which requires authorization for entry or egress. Access point 160 can be, for example, a kiosk, booth, doorway, or gate, through which vehicle 110 can enter or leave.

Vehicle 110 can be a waste management vehicle and can carry various ID mechanisms, such as personnel ID mechanism 112, vehicle ID mechanism 114, a hauler ID mechanism 116, and/or manifest ID mechanism 117. Personnel ID mechanism 112 can store a unique identification number, and/or other identification information, which can be used to identify a person (e.g., personnel 118 who operates vehicle 110). Vehicle ID mechanisms 114 can be used to identify vehicle 110. Hauler ID mechanism 116 can be used to identify a hauler company that owns or otherwise uses vehicle 110. Manifest ID mechanism 117 can store information about articles or items stored in vehicle 110.

In general, personnel ID mechanism 112, vehicle ID mechanism 114, hauler ID mechanism 116, and manifest ID mechanism 117 can be either radio frequency radio frequency identification (RFID) tags or barcodes that are used in any combination. For example, mechanisms 112 and 114 can be barcodes, and mechanisms 116 and 117 can be High Frequency Platform RFID tags from Texas Instruments Incorporated (Dallas, Tex.). Two or more of mechanisms 112, 114, 116, 117 can be stored on a single ID mechanism. RFID tags can be utilized as exemplary ID mechanisms.

Manifest ID mechanism 117 can also be a wireless computer with a memory device that can store information about articles stored in or carried by vehicle 110. This information can be stored in mechanism 117 automatically when vehicle 110 picks up articles (e.g., commercial or residential waste items) and identifies the articles by RFID tags attached to the articles. Thus, when vehicle 110 picks up articles from various sites it can keep a record of its contents, which can include a list of the amount and type of articles onboard vehicle 110.

Identification reader 124, biometric reader 126, and scale 128 are physically located near access point 160. Therefore, when vehicle 110 approaches access point 160, identification reader 124 can read identification information from ID mechanisms 112, 114, 116, and 117, biometric reader 126 can obtain biometric ID information from personnel 118, and scale 128 can weigh vehicle 110. Identification reader 124, biometric reader 126, and scale 128 can then transmit obtained information to computer 130.

Reader 124 can be a commercially available RFID tag reader system, such as the TI RFID™ series 2000, manufactured by Texas Instruments Incorporated (Dallas, Tex.). Alternatively, reader 124 can be a barcode reader, such as the DS6608 standard range imager, or the DS6600 Array Imager from Symbol Technologies, Inc. (Holtsville, N.Y.). In this case, ID mechanisms 112, 114, 116 can contain barcodes that respectively identify personnel 118, vehicle 110, and the hauler company that owns or otherwise uses vehicle 110.

Biometric reader 126 can be used for obtaining biometric ID information from vehicle personnel 118. Biometric ID information includes detectable physical human characteristics that can be used to identify a person who requests access to, or egress from, the controlled site. In some embodiments, biometric reader 126 can be configured to obtain data corresponding to one or more of fingerprints, retina, iris, voice, or face scans. However, embodiments of any other biometric identifiers can be used in connection with the present invention. Biometric reader 126 can be a commercially available biometric reader system, such as the Optical Capture Device CMOS Module, manufactured by Tacoma Technology Inc. (Taipei, Taiwan).

Scale 128 can be used to weigh vehicle 110. Scale 128 can be an industrial vehicle weighing scale, such as the Cougar weighing terminal, manufactured by Mettler-Toledo, Inc. (Columbus, Ohio).

Computer 130 can be a general-purpose computer that includes (or utilizes) industry-standard components such as display 132, storage device 138, a user interface (e.g., a keyboard and a mouse) (not shown), a processor (not shown), a modem (not shown), and/or a wireless link (not shown). Computer 130 also may include or utilize multiple software applications, such as access criteria software 134 and biometric verification software 136. In addition, computer 130 can include standard interfaces (e.g., universal serial bus (“USB”) ports) (not shown), to communicate with identification reader 124, biometric reader 126, and/or scale 128. Display 132 can be any standard video display, such as a computer monitor.

Furthermore, computer 130 can also include a recording device 180 for providing a hard copy record to personnel 118 of vehicle 110. For example, device 180 can be a printing device that prints a ticket that indicates whether vehicle 110 is authorized to proceed beyond access point 160. Alternatively, device 180 can be an electronic tag writer that records information in an electronic tag or badge that can be provided to personnel 118 of vehicle 110.

Storage device 138 can be a standard non-volatile memory device, such as a hard disk drive, that is used to store personnel 118 information in personnel repository 140, vehicle 110 information in vehicle repository 142, hauler information (e.g., company name) in hauler repository 144, materials repository 146, access criteria repository 148, biometrics repository 150, and operations repository 152. Repositories 140, 142, 144, 146, 148, 150, and 152 can be combined in any manner, or exist as separate repositories.

More particularly, personnel repository 140 can include personnel 118 names, identification numbers, Department of Transportation status, insurance status, medical and drug clearance, registration status, and/or equipment certification. Vehicle repository 142 can include vehicle identification numbers, vehicle registration, permit status, and/or approved vehicle weight. Hauler repository 144 can include hauler company names, vehicle identification numbers, vehicles associated with hauler companies, permit status of hauler companies, personnel associated with hauler companies, and/or waste approval numbers on hauler companies.

Materials repository 146 can include types of material that can be transported by a particular vehicle 110, and/or any restrictions that might be associated with these materials. Access criteria repository 148 can include names of authorized personnel 118, authorized haulers, authorized types of transports material, registrations and certifications required, insurances required, and/or authorized access times.

Biometrics repository 150 can include biometric data used to verify biometric ID information read by biometric reader 126. Operations repository 152 can contain include data obtained from ID mechanisms 112, 114, and/or 116 that is transmitted to computer 130 by identification reader 124, biometric reader 126, and/or scale 128.

Biometric verification software 136 can evaluate biometric information obtained from personnel 118. Biometric information received from personnel 118 can be compared to data stored in biometrics repository 150, to determine whether the biometric information corresponds to authorized personnel having one or more forms of biometric information stored in biometrics repository 150.

Access criteria software 134 evaluates data obtained from ID mechanisms 112, 114, 116, 117 and/or scale 128, which can be stored in operations repository 152. Data obtained from ID mechanisms 112, 114, 116, 117 and/or scale 128 can be compared to data stored in repositories 140, 142, 144, 146, and/or 148, to determine whether vehicle 110 is authorized by matching or coordinating the data obtained from mechanisms 112, 114, 116, 117 and/or scale 128 with data stored in repositories 104, 152, 14, 146 and/or 148. Access criteria software 134 can further receive verification from biometric verification software 136 in making this determination. The decision to approve or deny access made by access criteria software 134 may be displayed on display 132, which is normally viewable by a personnel in charge of entry through access point 160, who acts according to the decision displayed. In some embodiments, software 134 can be used to facilitate automatically opening a gate to provide access beyond access point 160. Access criteria software 134 can operate in conjunction with a gate access controller (not shown) to enable or facilitate access vehicle 110 proceeding beyond the access point 160.

Examples of how access criteria software 134 evaluates data using access criteria repository 148 and operations repository 152 is described below in connection with Tables 1 and 2. Table 1, which is an exemplary access criteria repository 148, includes a list of valid personnel IDs, vehicle IDs, hauler IDs, and weight.

TABLE 1
Exemplary access criteria repository 148

| Valid | Valid | Valid | |
|---|---|---|---|
| Personnel ID's | Vehicle ID's | Hauler ID's | Valid Weight |
| 1, 2, 4, 6 | 2, 3, 7, 12 | 2, 6, 10 | 10 Ton Maximum |

Therefore, in this example, the authorization requirements are a valid personnel 118 ID, a valid vehicle 110 ID, a valid hauler ID, and that the vehicle 110 requesting access does not exceed a maximum weight. These authorization requirements are matched against the data read from ID mechanisms 112, 114, and 116. Table 1 is but one example set of access requirements. There can be any number of access requirements, that may include or utilize biometric verification of personnel.

In addition, system 100 can also be used to verify that vehicle 110 has exited from, or beyond, access point 160. For example, as discussed above, operations repository 152 can contain include data obtained from ID mechanisms 112, 114, and/or 116 and transmitted to computer 130 by identification reader 124, biometric reader 126, and/or scale 128. In addition to this information, operations repository 152 can also include a record of whether vehicle 110 exited from, or beyond, access point 160. Vehicle 110 can exit from access point 160 in a same or similar manner as system 100 initially allowed vehicle 110 to proceed beyond access point 160 (e.g., by system 100 reading and verifying personnel ID mechanism 112 and vehicle ID mechanism 114).

Thus, for example, if, at the end of the day (or another predetermined time subsequent to system 100 authorizing vehicle 110 to initially proceed beyond access point 160) operations repository 152 indicates that vehicle 110 has not exited from access point 160, computer 130 may provide an alert to display 132 and/or provide another visual and/or audible alert to access point 160 personnel indicating that vehicle 110 has not left access point 160.

Table 2 is an exemplary of operations repository 152. For each request for entry at access point 160, repository 152 can store, for example, a personal 118 ID, a vehicle 110 ID, a hauler ID, and weight of vehicle respectively obtained from ID mechanisms 112, 114, 116 and scale 128, as well as the date and time of the request. Access criteria software 134 determines whether the personnel 118 ID, vehicle 110 ID, hauler ID, and vehicle weight associated with a request for entry matches the identification criteria and vehicle 110 weight criteria stored in access criteria repository 148.

TABLE 2
Exemplary operations repository 152

| | | | Authori- | |
|---|---|---|---|---|
| | | | zation | |
| Access point | Access point ID | Data | action | |
| request | mechanism data | validity | taken | COMMENT |
| Request # 1 | Personnel ID = 1 | Valid | Access to | All |
| Oct. 12, 2005 | Vehicle ID = 3 | Valid | controlled | require- |
| 9:48 am | Hauler ID = 7 | Valid | site | ments |
| | Weight = 9.1 tons | Valid | granted | valid |
| Request # 2 | Personnel ID = 2 | Valid | Access to | Invalid |
| Oct. 12, 2005 | Vehicle ID = 1 | Not | controlled | vehicle |
| 9:57 am | | valid | site | ID |
| | Hauler ID = 6 | Valid | denied | |
| | Weight = 8.3 tons | Valid | | |
| Request #3 | Personnel ID = 4 | Valid | Access to | Invalid |
| Oct. 12, 2005 | Vehicle ID = 2 | Valid | controlled | hauler |
| 11:10 am | Hauler ID = 5 | Not | site | ID |
| | | valid | denied | |
| | Weight = 7.5 tons | Valid | | |

For example, with regard to Table 2, access criteria software 134 determines that request #1 is associated with personnel 118 ID, a vehicle 110 ID, a hauler ID, and a vehicle weight that are all valid for authorized entry through access point 160. However, for request #2, the vehicle 110 ID 1 is not authorized for entry, because access criteria software 134 determines that it does not match any of the valid vehicle IDs stored in access criteria repository 148 (Table 1). For request #3, hauler ID 5 is not authorized for entry, because it does not match any of the valid hauler IDs stored in access criteria repository 148 (Table 1). Therefore, persons and vehicles requesting entry in request #2 and #3 are not permitted to enter. When a vehicle is allowed to enter, a hard copy record of authorization can be provided to personnel of the vehicle using recording device 180.

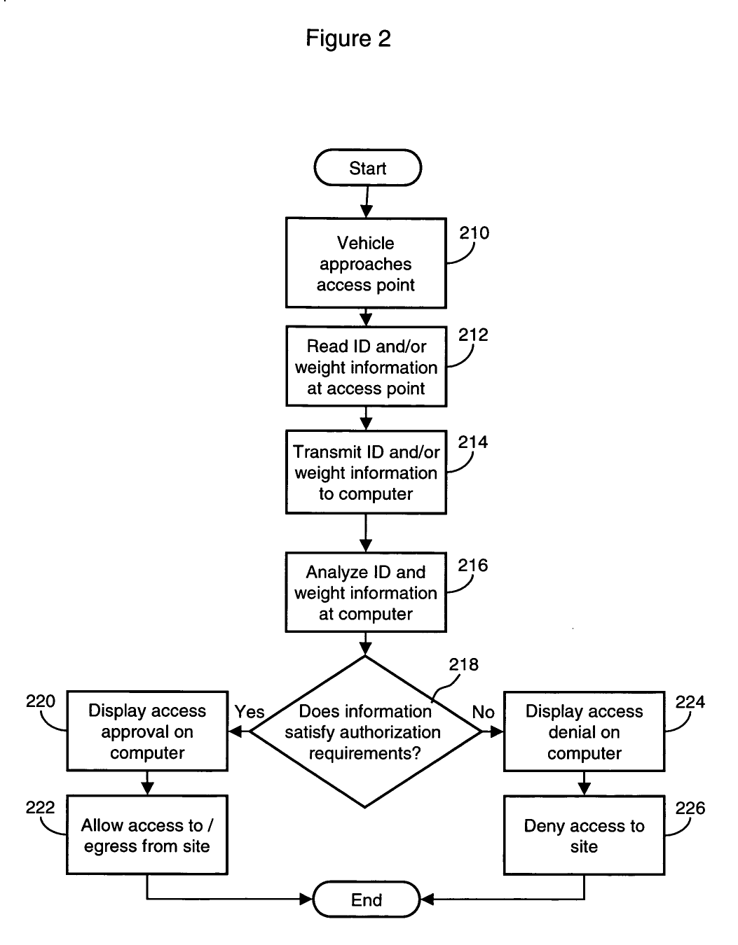

FIG. 2 is a flow chart illustrating a method for controlling access to a site. At step 210, vehicle 110 approaches access point 160 of a controlled site and optionally drives onto scale 128 to obtain the weight of vehicle 110. At step 212, identification reader 124 can read ID information from various ID mechanisms (e.g., mechanisms 112, 114, 116, and 117) associated with vehicle 110 and/or personnel 118. Biometric reader 126 also can obtain biometric ID information from personnel 118.

At step 214, information obtained by identification reader 124, biometric reader 126, and/or scale 128 is transmitted to computer 130, which can store the information in operations repository 152. At step 216, this transmitted information can be analyzed by computer 130, using access criteria software 134 and biometric verification software 136, to determine whether authorization requirements are satisfied, in a manner such as described above in connection with Tables 1 and 2. In making this determination, software 134 and 136 may utilize data contained in personnel repository 140, vehicle repository 142, hauler repository 144, materials repository 146, access criteria repository 148, and/or biometrics repository 150. In addition, software 134 can use information read from manifest ID mechanism 117 to determine if the contents of vehicle 110 are allowed to enter the site. For example, if hazardous materials are present in vehicle 110, access may be denied.

At decision step 218, if authorization requirements are satisfied, access approval can be displayed on display 132 at step 220. At step 222, vehicle 110 is allowed access to, and subsequent egress from, the site. For example, system 100 can transmit a signal to an automatic gate at access point 160, instructing the gate to open and thereby permitting vehicle 110 to proceed. When vehicle 110 subsequently leaves the site, vehicle 110 can present the same or similar authorization mechanisms that allowed vehicle 110 to initially proceed beyond access point 160 (e.g., personnel ID mechanism 112 and vehicle ID mechanism 114). By system 110 also verifying vehicle 110 egress, computer 130 may provide an alert to display 132 and/or provide another visual and/or audible alert to access point 160 personnel indicating that vehicle 110 has not left access points 160.

If it is determined at decision step 218 that authorization requirements are not satisfied, then, at step 224 computer 130 can cause display 132 to indicate that access to site 160 is denied. Accordingly, access to site 160 is denied at step 226.

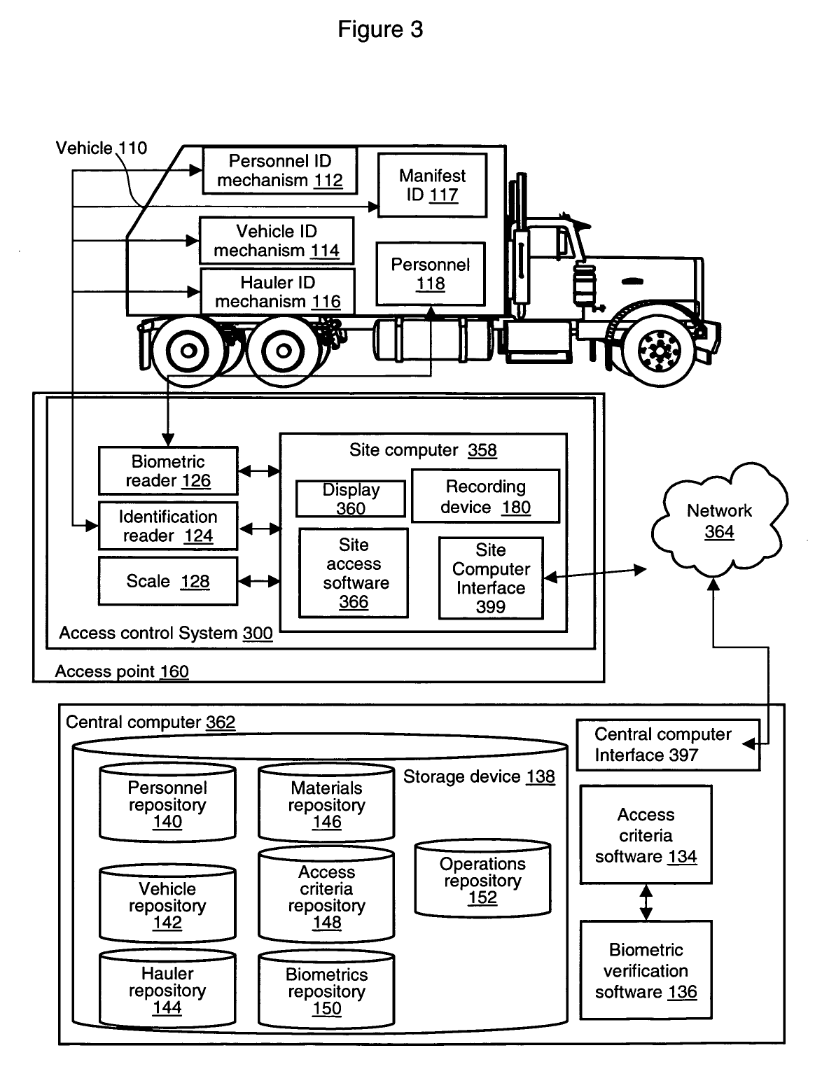

FIG. 3 is a functional block diagram depicting another access control system 300, along with vehicle 110 and central computer 362. System 300 can include identification reader 124, biometric reader 126, scale 128, site computer interface 399, and site computer 358. Identification reader 124, biometric reader 126, and scale 128 have been described in connection with system 100 in FIG. 1. In system 300, storage device 138, software 134 and 136 are included in computer 362, which communicates with system 300 through network 364.

Identification reader 124, biometric reader 126, and scale 128 are physically located at or proximate access point 160. Therefore, when vehicle 110 approaches access point 160, identification reader 124 can read identification information from ID mechanisms 112, 114, 116, and 117, biometric reader 126 can obtain biometric information from personnel 118, and scale 128 can weigh vehicle 110. Identification reader 124, biometric reader 126, and scale 128 can then transmit obtained information to site computer 358.

Site computer 358 can include or otherwise utilize site access software 366 and display 360. Site computer 358 can be installed at, or proximate access point 160 of a controlled site. Central computer 362 can include central computer interface 397. Computer 358 and 362 can be general-purpose computers that include industry-standard components. Computers 358 and 362 can be connected via network 364 through site computer interface 399 and/or central computer interface 397. Therefore, central computer 362 can be remotely accessed by site computer 358. Network 364 can be a standard local area network (LAN) or wide area network (WAN).

When vehicle 110 arrives at access point 160, site access software 366 can transmit information obtained from identification reader 124, biometric reader 126, and/or scale 128 to operations repository 152. Software 134, 136 can determine whether vehicle is authorized to proceed beyond access point 160, by comparing this information to data stored in repositories 140, 142, 144, 146, 148, and/or 150, as described previously in connection with system 100. Software 134 can operate in conjunction with a gate access controller (not shown) to enable or facilitate access vehicle 110 proceeding beyond the access point 160.

Once the determination is made, computer 362 transmits the determination to computer 358 via network 364 using interfaces 399 and/or 397. Computer 358 may then display this determination on display 360, and allow or deny access for vehicle 110 based on this determination.

As similarly discussed above in connection with FIG. 1, system 300 can also be used to verify that vehicle 110 has exited from or beyond access point 160. For example, as discussed above, operations repository 152 can contain include data obtained from ID mechanisms 112, 114, and/or 116 and transmitted to computer 362 by identification reader 124, biometric reader 126, and/or scale 128. In addition to this information, operations repository 152 can also include a record of whether vehicle 110 has exited from, or beyond, access point 160. Vehicle 110 can exit from access point 160 in a same or similar manner as system 300 initially allowed vehicle 110 to proceed beyond access point 160 (e.g., by system 100 reading and verifying personnel ID mechanism 112 and vehicle ID mechanism 114).

Thus, for example, if, at the end of the day (or another predetermined time subsequent to system 300 authorizing vehicle 110 to initially proceed beyond access point 160) operations repository 152 indicates that vehicle 110 has not exited from, or beyond, access point 160, computer 358 may provide an alert to display 360 and/or provide another visual and/or audible alert to access point 160 personnel indicating that vehicle 110 has not left access point 160. Recording device 180 operates generally as described in connection with FIG. 1.

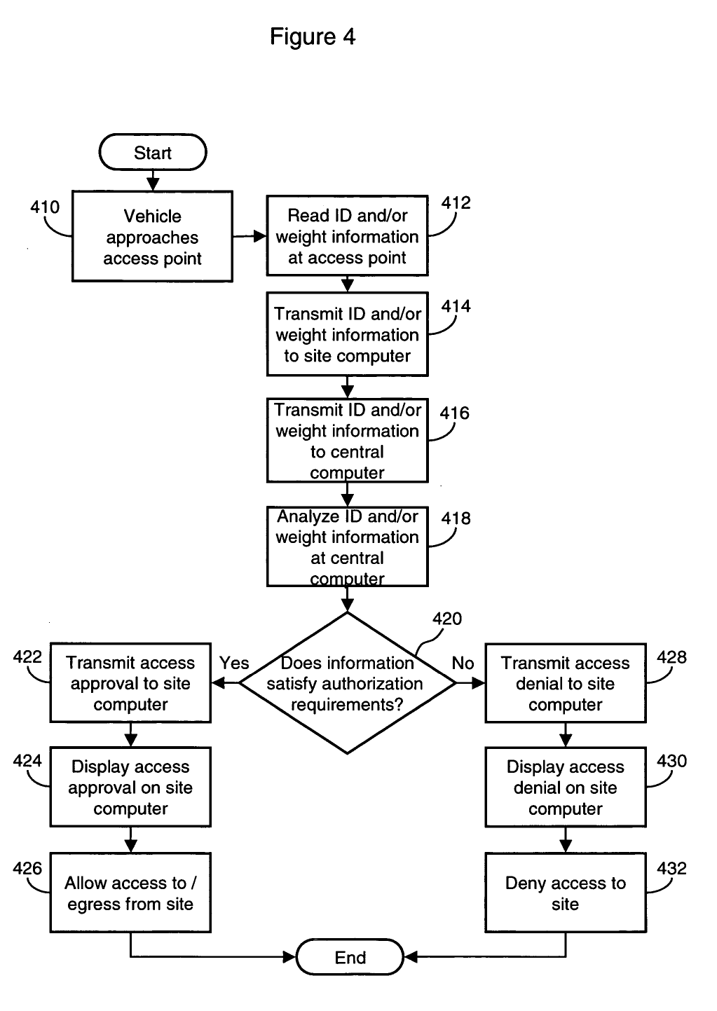

FIG. 4 is a flow chart illustrating a method of authorizing access to a site using system 300. At step 410, vehicle 110 approaches access point 160 of a controlled site and optionally drives onto scale 128 to obtain the weight of vehicle 110. At step 412, identification reader 124 can obtain ID information from various ID mechanisms (e.g., mechanisms 112, 114, 116) carried by vehicle 110 and/or personnel 118. Biometric reader 126 also can obtain biometric ID information from personnel 118.

At step 414, information obtained by identification reader 124, biometric reader 126, and/or scale 128 can be transmitted to computer 358. At step 416, the information can be transmitted to computer 362 via network 364 (shown in FIG. 3), and stored in operations repository 152. At step 418, computer 362 can analyze the information, using access criteria software 134 and/or biometric verification software 136, to determine whether authorization requirements are satisfied.

At decision step 420, if computer 362 determines that authorization requirements are satisfied, then, at step 422, computer 362 transmits access approval to computer 358, which can then display this access approval on display 360 at step 424 and allow access at step 426. At step 426, system 300 can also be used to verify that vehicle 110 has subsequently exited from, or beyond, access point 160. For example, system 300 can transmit a signal to an automatic gate at access point 160, instructing the gate to open and thereby permitting vehicle 110 to proceed. When vehicle 110 subsequently leaves the site, vehicle 110 can present the same or similar authorization mechanisms that allowed vehicle 110 to initially proceed beyond access point 160 (e.g., personnel ID mechanism 112 and vehicle ID mechanism 114). By system 300 also verifying vehicle 110 egress, computer 358 may provide an alert to display 360 and/or provide another visual and/or audible alert to access point 160 personnel indicating that vehicle 110 has not left access points 160.

If it is determined at decision step 420 that authorization requirements are not satisfied, then, at step 428 computer 362 transmits access denial to computer 358. At step 430, site computer 358 can then display this access denial on display 360, and deny access at step 432.

Other embodiments, extensions, and modifications of the ideas presented above are comprehended and within the reach of one skilled in the art upon reviewing the present disclosure. Accordingly, the scope of the present invention in its various aspects should not be limited by the examples and embodiments presented above. The individual aspects of the present invention, and the entirety of the invention should be regarded so as to allow for modifications and future developments within the scope of the present disclosure. The present invention is limited only by the claims that follow.

1. A system for authorizing a waste management vehicle to proceed beyond an access point of a waste receivable environment, comprising:
an identification reader configured to obtain waste management vehicle identification information, hauler identification information, and personnel identification information from at least one identification mechanism;
a biometric reader configured to obtain biometric information from a personnel of the waste management vehicle; and
a computer system configured to receive the waste management vehicle identification information, hauler identification information, personnel identification information and the biometric information, determine whether the waste management vehicle and the personnel are authorized to proceed beyond an access point of a waste receivable environment using the waste management vehicle identification information, hauler identification information, personnel identification information and biometric information, and transmit a signal to a control mechanism to allow the waste management vehicle and the personnel to proceed beyond the access point of the waste receivable environment.

2. The system of claim 1, wherein the identification reader comprises a barcode reader.

3. The system of claim 1, wherein the identification reader comprises a radio frequency identification reader.

4. The system of claim 1, wherein the biometric reader is configured to obtain at least one of a fingerprint, a voice sample, a facial image, and an eye image from the personnel.

5. The system of claim 1, further comprising a scale configured to obtain the weight of the waste management vehicle in determining if the vehicle is authorized to proceed beyond the access point of the waste management environment.

6. The system of claim 1, further comprising a display, wherein the computer system is further configured to send a message to the display, the message indicating whether the waste management vehicle is authorized to proceed beyond the access point of the waste management environment.

7. The system of claim 1, further comprising a gate access controller for allowing an authorized waste management vehicle and personnel to automatically proceed beyond the access point of the waste management environment.

8. The system of claim 1, wherein the computer system is a computer located near the access point of the waste management environment.

9. The system of claim 1, wherein the computer system comprises a computer remotely accessed via a network, the computer storing data pertaining to vehicle, hauler, and personnel authorization requirements.

10. The system of claim 9, wherein the data pertaining to vehicle, hauler, and personnel authorization requirements are respectively stored in a vehicle repository, hauler repository, and a personnel repository.

11. The system of claim 1, further comprising at least one of a hauler repository, a materials repository, an access criteria repository, a biometrics repository, and an operations repository.

12. The system of claim 1, wherein the identification reader is further configured to obtain information about contents of the waste management vehicle from at least one content information mechanism.

13. The system of claim 1, wherein the system further confirms that the waste management vehicle has exited from the access point of the waste receivable environment by receiving a second time at least one of the vehicle identification and biometric information.

14. The system of claim 13, wherein when the system does not receive the second time at least one of the vehicle identification and biometric information within a predetermined time period of receiving a first vehicle identification and biometric information, the system provides at least one of a visual and audible alert.

15. A method for authorizing a waste management vehicle to proceed beyond an access point of a waste receivable environment, comprising:
reading waste management vehicle identification information, hauler identification information, and personnel identification information from at least one identification tag;
reading biometric information from at least one person; and
using the waste management vehicle identification information, hauler identification information, personnel identification information and the biometric information to determine whether the waste management vehicle is authorized to proceed beyond the access point of the waste receivable environment.

16. The method of claim 16, further comprising allowing the waste management vehicle to proceed beyond the access point of the waste receivable environment upon determining that the vehicle is authorized.

17. The method of claim 16, wherein reading identification information comprises reading at least one barcode.

18. The method of claim 16, wherein reading waste management vehicle identification information, hauler identification information, and personnel identification information comprises reading at least one radio frequency identification tag.

19. The method of claim 19, wherein reading waste management vehicle identification information, hauler identification information, and personnel identification information comprises reading a first radio frequency identification tag containing the waste management vehicle identification information, reading a second radio frequency identification tag containing the hauler identification information, and reading a third radio frequency identification tag containing the personnel identification information.

20. The method of claim 15, wherein the biometric information comprises a fingerprint.

21. The method of claim 15, wherein the biometric information comprises a voice sample.

22. The method of claim 15, wherein the biometric information comprises a facial image.

23. The method of claim 15, wherein the biometric information comprises an eye image.

24. The method of claim 15, further comprising:
obtaining a weight of the waste management vehicle; and
using at least one of the waste management vehicle identification information, the hauler identification information, the personnel identification information, the biometric information, and the vehicle weight to determine whether the waste management vehicle is authorized to proceed beyond the access point of the waste receivable environment.

25. The method of claim 15, further comprising displaying whether the waste management vehicle is authorized to proceed beyond the access point of the waste receivable environment.

26. The method of claim 15, further comprising allowing the waste management vehicle to proceed beyond the access point of the waste receivable environment using an automated gate access controller, upon determining that the vehicle is authorized.

27. The method of claim 26, wherein the determination is further based at least in part upon contents of the waste management vehicle.
